(19) United States
(12) Patent Application Publication
(10) Pub. No.: US 2014/0084083 A1
(43) Pub. Date: Mar. 27, 2014

(54) Fluid-Dispensing Nozzle

(71) Applicant: Akron Brass Company, Wooster, OH (US)

(72) Inventors: Jon A. Jenkins, Wooster, OH (US); David Durstine, Wooster, OH (US)

(73) Assignee: AKRON BRASS COMPANY, Wooster, OH (US)

(21) Appl. No.: 14/032,749

(22) Filed: Sep. 20, 2013

Related U.S. Application Data
(60) Provisional application No. 61/703,847, filed on Sep. 21, 2012.

(51) Int. Cl. B05B 1/12

(52) U.S. Cl. CPC B05B 1/12
USPC 239/393; 29/890.142

(57) ABSTRACT

A fluid-dispensing nozzle including a nozzle body. A discharge tube is disposed in the nozzle body and has a plurality of cam grooves. The nozzle further includes a rotatable flow control. A pin is coupled to the flow control and rotatably engages a select cam groove such that rotation of the flow control causes the pin to rotatably slide in the select cam groove, causing the discharge tube to move linearly. A first and a second insert are coupled to the nozzle body, the first insert having a cam slot. The nozzle also includes a rotatable pattern sleeve. A cam follower is coupled to the pattern sleeve and engages the cam slot of the first insert. A determinable pattern of motion of the pattern sleeve is controlled by the first and second inserts. The first and second inserts are rearrangeable to change the pattern of motion of the pattern sleeve.

### CROSS-REFERENCE TO RELATED APPLICATIONS

This application claims priority to U.S. provisional application 61/703,847, filed Sep. 21, 2012, the entire contents of which are hereby incorporated by reference.

### FIELD

The present invention relates generally to fluid-dispensing nozzles, in particular to configurable fluid-dispensing nozzles.

### BACKGROUND

Conventionally, a nozzle is connected to an end portion of a fire hose and is used to direct fluids discharged from the hose. The nozzle is sometimes provided with an on/off mechanism for selectably controlling the discharge of fluids from the nozzle. Some nozzles also provide means for varying the flow rate of the fluids and/or the pattern in which fluids are discharged.

Many nozzles that are used in conjunction with firefighting apparatus are highly sophisticated pieces of equipment, containing a number of complex interconnected components. The more components involved, the more labor is required to produce the nozzles, adding to the expense. Consequently, many cost-constrained firefighting organizations have fewer nozzles in their inventory than is desirable. What is needed is a nozzle that is cost-effective to produce without compromising operating characteristics or reliability.

### SUMMARY

The present invention provides for a nozzle that utilizes a single polymer piece rather than a plurality of components for a pattern sleeve and bumpers. In addition, several cam grooves may be formed in a discharge tube of the nozzle for controlling the amount of water discharged by the nozzle. A first cam groove is usable with a variable flow nozzle, while a second cam groove is usable with a fixed-flow fluid nozzle.

The nozzle of the present invention may also include inserts coupled to a body of the nozzle, at least one insert having a cam slot that operates in conjunction with a pattern sleeve to control the discharge pattern of the nozzle. The position of the inserts may be rearranged in the field, selectably configuring the operation of the pattern sleeve between a National Fire Protection Association (NFPA) nozzle (typically a U.S. version) and a Conformite' Europe'enne (CE) nozzle (typically a European version).

One aspect of the present invention is a fluid-dispensing nozzle. The nozzle comprises a nozzle body. A discharge tube is disposed in the nozzle body, the discharge tube having a plurality of cam grooves. The nozzle further includes a flow control, the flow control being rotatable with respect to the nozzle body. A pin is coupled to the flow control, the pin rotatably engaging a select cam groove. Rotation of the flow control causes the pin to rotatably slide in the select cam groove, causing the discharge tube to move linearly.

Another aspect of the present invention is fluid-dispensing nozzle having a nozzle body. A first insert is coupled to the nozzle body, the first insert having a cam slot. A second insert is also coupled to the nozzle body. The nozzle further includes a rotatable pattern sleeve. A cam follower is coupled to the pattern sleeve, the cam follower further engaging the cam slot of the first insert. A determinable pattern of motion of the pattern sleeve is controlled by the first and second inserts. In addition, the first and second inserts are rearrangeable to change the pattern of motion of the pattern sleeve.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a perspective view of a fluid-dispensing nozzle according to an embodiment of the present invention;

FIG. 2 is a view in section of the fluid-dispensing nozzle of FIG. 1;

FIG. 3 is a partially disassembled, cutaway view of a portion of the fluid-dispensing nozzle of FIG. 1, showing details of a discharge tube of the fluid-dispensing nozzle of FIG. 1; and

FIG. 4 is an exploded-view showing relevant elements of the fluid-dispensing nozzle of FIG. 1.

### DETAILED DESCRIPTION

In the discussion that follows, like reference numerals are used to refer to like elements and structures in the various figures.

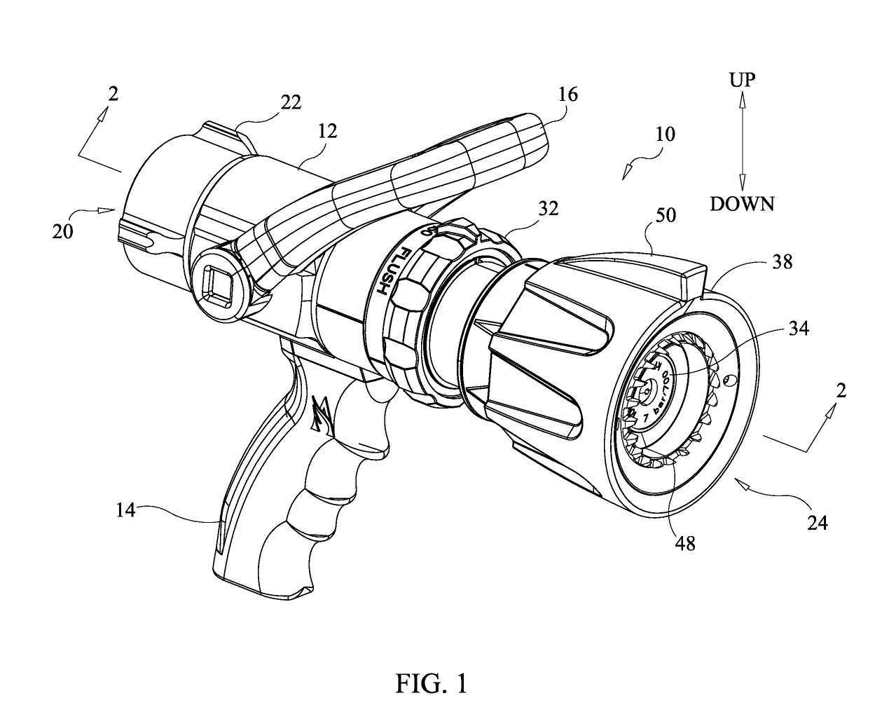

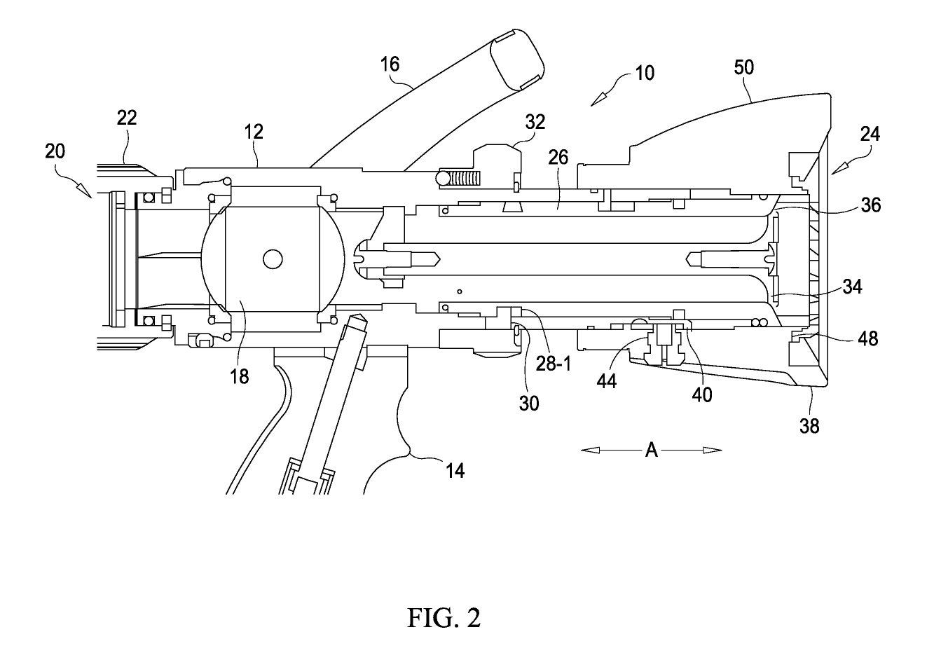

The general arrangement of a nozzle assembly 10 is shown in FIGS. 1 and 2 according to an embodiment of the present invention. Nozzle assembly 10 includes a nozzle body 12 having a hand grip 14. A shutoff handle 16 is pivotably coupled to nozzle body 12 for controlling the flow of fluids through nozzle assembly 10. In various embodiments of the present invention shutoff handle 16 may be configured as an On-Off fluid flow control, or as a variable-flow fluid control.

In some embodiments shutoff handle 16 is coupled to a flow-controlling ball 18 disposed in the nozzle body 12 such that pivoting the shutoff handle causes the ball to move rotatably in an inlet 20 of nozzle body 12. Ball 18 is generally solid and has a bore disposed therethrough, forming ports at opposing ends of a closed wall. In operation, moving handle 16 such that the bore of the ball is generally aligned with inlet 20 allows pressurized fluid supplied to a swivel 22 of nozzle assembly 10 to flow through the inlet, nozzle body 12, and an outlet 24, exiting the nozzle assembly at the outlet. Moving handle 16 such that the bore of ball 18 is less aligned with inlet 20 (i.e., at an angle to the inlet) reduces the flow of pressurized fluid through nozzle assembly 10. Nozzle assembly 10 is in an “Off” condition with essentially no fluid flowing therethrough when the bore of ball 18 is rotated completely out of alignment with inlet 20, thus leaving only the closed wall of the ball to confront pressurized fluid at the inlet.

With reference to FIG. 2, a discharge tube 26 includes a cam groove 28. A pin 30 is attached to, and extends from, a flow control ring 32 and into cam groove 28. Flow control ring 32 is rotatable with respect to nozzle body 12. As flow control ring 32 is rotated pin 30 slides in cam groove 28, causing the rotary motion of the pin to be converted to a corresponding linear motion wherein discharge tube 26 moves in a linear fashion along an axis “A” within nozzle body 12. Pin 30 thus controls the position of discharge tube 26 relative to a baffle head 34 of the nozzle, thereby opening or closing a gap 36 between the discharge tube and baffle head 34, which in turn either allows more or less fluid to flow out of outlet 24, depending on the position of the discharge tube.

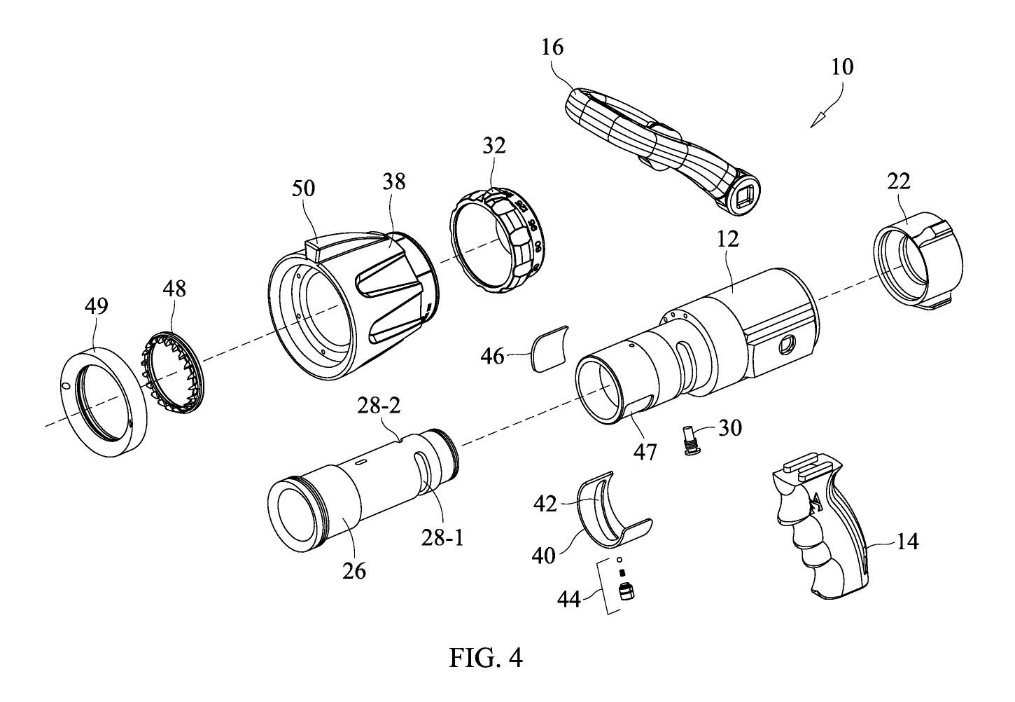

In some embodiments of the present invention a plurality of cam grooves 28 may be formed in discharge tube 26. For example, a first cam groove 28-1 may be formed that is usable with a variable-flow nozzle, while a second cam groove 28-2 may be formed that is usable with a fixed-flow fluid nozzle. First and second cam grooves 28-1, 28-2 may be formed as opposing grooves as shown in FIG. 4 such the nozzle 10 may be configured (or reconfigured) as a variable-flow fluid nozzle or a fixed-flow fluid nozzle by appropriate positioning of discharge tube 26 in the assembly of the nozzle.

The spray pattern of fluids discharged from outlet 24 of nozzle assembly 10 is selectably set by rotatably adjusting the position of a pattern sleeve 38 with respect to nozzle body 12. The pattern of fluid emitted from outlet 24 of nozzle assembly 10 is adjustable from a generally narrowly-focused stream to a widely-diffused “fog.” Further details of the spray pattern adjustment arrangement of nozzle 10 is provided below.

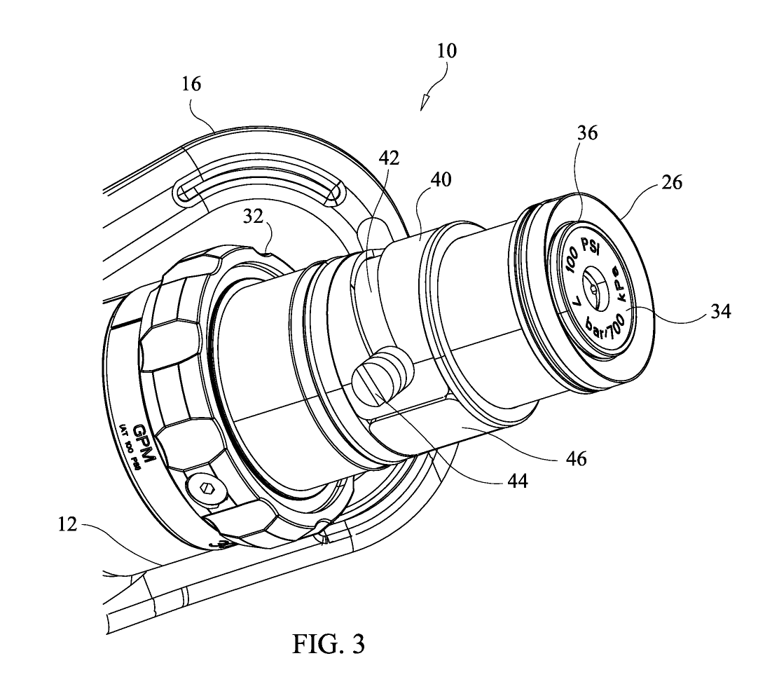

With reference to FIGS. 1 through 4 together, in one embodiment one or more inserts may be coupled to nozzle body 12. In a preferred embodiment a first insert 40 has a cam profile or slot 42 that is adapted to slidably receive a cam follower 44, while a second insert 46 acts as a spacer for the first insert. Cam follower 44 is fixedly coupled to pattern sleeve 38. Pattern sleeve 38, in turn, is rotatably coupled to nozzle body 12 such that cam follower 44 is slidably disposed in cam slot 42. In some embodiments first and second inserts 40, 46 respectively may be detachably received by a receptacle 47 of nozzle body 12.

In operation of pattern sleeve 38, as the pattern sleeve is rotated cam follower 44 slidably traverses in cam slot 42, causing the rotary motion of the cam follower to be converted to a corresponding linear motion wherein the pattern sleeve moves in a linear fashion with respect to nozzle body 12. Cam follower 44 thus controls the position of pattern sleeve 38 relative to baffle head 34 of the nozzle, moving a pattern control element 48 of the pattern sleeve toward or away from the baffle head. This action adjusts the pattern of fluid exiting from outlet 24 from a relatively narrowly-focused stream to a widely-diffused “fog.” Pattern control element 48 may be retained by a retaining ring 49, as shown in FIG. 4.

In some embodiments of the present invention inserts 40, 46 may be rearranged or reversed in the field, thereby allowing pattern sleeve 38 to rotate through an extended range of motion such that a raised lug 50 (FIG. 1) is no longer oriented generally upwardly when the nozzle 10 is in the straight stream position. Instead, when the raised lug 50 is in the aforementioned straight-up position in this alternate configuration, this position represents a narrow fog position of the nozzle stream. This meets the requirements for most European (CE) nozzles. In some embodiments of the present invention the extended range of motion is about sixty additional degrees.

In some embodiments of the present invention pattern sleeve 38 is made from a single piece from a suitable material such as, but not limited to, a polymer material, metal, and composites. Cam inserts 40, 46 are preferably made from a durable material, such as stainless steel, to deter wear in cam slot 42 due to the slidable movement of cam follower 44 in the cam slot. Discharge tube 26 may be made from any suitable material, including metal such as aluminum or stainless steel, composites and plastics.

While this invention has been shown and described with respect to a detailed embodiment thereof, it will be understood by those skilled in the art that changes in form and detail thereof may be made without departing from the scope of the claims of the invention.

What is claimed is:

1. A fluid-dispensing nozzle, comprising:
a nozzle body;
a discharge tube disposed in the nozzle body, the discharge tube having a plurality of cam grooves;
a flow control, the flow control being rotatable with respect to the nozzle body; and
a pin coupled to the flow control, the pin rotatably engaging a select cam groove,
wherein rotation of the flow control causes the pin to rotatably slide in the select cam groove, causing the discharge tube to move linearly.

2. The fluid-dispensing nozzle of claim 1 wherein a first cam groove is usable with a variable-flow fluid dispensing nozzle.

3. The fluid-dispensing nozzle of claim 2 wherein a second cam groove is usable with a fixed-flow fluid dispensing nozzle.

4. The fluid-dispensing nozzle of claim 1 wherein the nozzle body further includes a hand grip.

5. The fluid-dispensing nozzle of claim 1, further including a shutoff handle pivotably coupled to the nozzle body.

6. The fluid-dispensing nozzle of claim 5, further comprising a flow-controlling ball disposed in the nozzle body, the flow-controlling ball being coupled to the shutoff handle.

7. The fluid-dispensing nozzle of claim 5 wherein the shutoff handle is configured as a variable-flow fluid control.

8. The fluid-dispensing nozzle of claim 5 wherein the shutoff handle is configured as an on-off fluid flow control.

9. A fluid-dispensing nozzle, comprising:
a nozzle body;
a first insert coupled to the nozzle body, the first insert having a cam slot;
a second insert coupled to the nozzle body;
a rotatable pattern sleeve; and
a cam follower coupled to the pattern sleeve, the cam follower further engaging the cam slot of the first insert,
a determinable pattern of motion of the pattern sleeve being controlled by the first and second inserts, and
the first and second inserts being rearrangeable to change the pattern of motion of the pattern sleeve.

10. The fluid-dispensing nozzle of claim 9 wherein the pattern sleeve is made from a single piece.

11. The fluid-dispensing nozzle of claim 10 wherein the pattern sleeve is made from a polymer material.

12. The fluid-dispensing nozzle of claim 9 wherein the first and second inserts are made from stainless steel.

13. A fluid-dispensing nozzle, comprising:
a nozzle body;
a discharge tube disposed in the nozzle body, the discharge tube having a plurality of cam grooves;
a rotatable flow control;
a pin coupled to the flow control, the pin rotatably engaging a select cam groove such that rotation of the flow control causes the pin to rotatably slide in the select cam groove, causing the discharge tube to move linearly;
a first insert coupled to the nozzle body, the first insert having a cam slot;
a second insert coupled to the nozzle body;
a rotatable pattern sleeve; and
a cam follower coupled to the pattern sleeve, the cam follower further engaging the cam slot of the first insert,
a determinable pattern of motion of the pattern sleeve being controlled by the first and second inserts, and
the first and second inserts being rearrangeable to change the pattern of motion of the pattern sleeve.

14. The fluid-dispensing nozzle of claim 13 wherein the pattern sleeve is made from a single piece.

15. The fluid-dispensing nozzle of claim 14 wherein the pattern sleeve is made from a polymer material.

16. The fluid-dispensing nozzle of claim 13 wherein the first and second inserts are made from stainless steel.

17. A method for making a fluid-dispensing nozzle, comprising the steps of:
obtaining a nozzle body;
disposing a discharge tube in the nozzle body, the discharge tube having a plurality of cam grooves;
obtaining a flow control, the flow control being rotatable with respect to the nozzle body;
coupling a pin to the flow control, the pin rotatably engaging a select cam groove such that rotation of the flow control causes the pin to rotatably slide in the select cam groove, causing the discharge tube to move linearly;
coupling a first insert to the nozzle body, the first insert having a cam slot;
coupling a second insert to the nozzle body;
obtaining a rotatable pattern sleeve, the pattern sleeve being made from a single piece of polymer material; and
coupling a cam follower to the pattern sleeve, the cam follower further engaging the cam slot of the first insert,
a determinable pattern of motion of the pattern sleeve being controlled by the first and second inserts, and
the first and second inserts being rearrangeable to change the pattern of motion of the pattern sleeve.

18. The method of claim 17, further comprising the step of making the pattern sleeve from a single piece.

19. The method of claim 18, further comprising the step of making the pattern sleeve from a polymer material.

20. The method claim 17, further comprising the step of making the first and second inserts from stainless steel.
